(19) United States
(12) Patent Application Publication
(10) Pub. No.: US 2015/0036230 A1
(43) Pub. Date: Feb. 5, 2015

(54) OPTICAL IMAGING LENS

(71) Applicant: GENIUS ELECTRONIC OPTICAL CO., LTD., Taichung City (TW)

(72) Inventors: Matthew Bone, Fremont, CA (US); Tzu-Chien Tang, Taichung (TW)

(21) Appl. No.: 14/341,600

(22) Filed: Jul. 25, 2014

Related U.S. Application Data
(60) Provisional application No. 61/860,904, filed on Jul. 31, 2013.

(51) Int. Cl. G02B 9/64

(52) U.S. Cl. CPC G02B 9/64
USPC 359/754

(57) ABSTRACT

An optical imaging lens includes, in order from an object side to an image side, first, second, third, fourth, fifth, sixth, seventh, and eighth lens elements. The first lens element has a negative refractive power, a convex portion on the object-side surface near the outer circumference and a concave portion on the image-side surface near the optical axis. The object-side surface and the image-side surface of the fourth lens element each have a concave portion near the optical axis. The object-side surface of the fifth lens element has a convex portion near the optical axis. The object-side surface and the image-side surface of the sixth lens element each have a convex portion near the optical axis. The eighth lens element has a positive refractive power, and a convex object-side surface. The optical imaging lens only has eight lens elements having a refractive power.

### CROSS-REFERENCES TO RELATED APPLICATIONS

This application claims the benefit of U.S. Provisional Application No. 61/860,904, filed Jul. 31, 2013, the content of which is incorporated herein by reference in its entirety.

### BACKGROUND

The present invention relates to an optical imaging lens, and more particularly to an optical imaging lens having eight lens elements.

The continuous need for high resolution imaging imposes demand in high light gathering capability in optical lens systems. As the number of pixels in an image sensor increases, an optical lens system for a camera having high optical performance is needed. Accordingly, the present invention provides optical lens systems with improved optical characteristics and high resolution.

### SUMMARY

Certain embodiments of the present invention relate to an optical imaging lens having eight lens elements. In some embodiments, an optical imaging lens includes, in order from an object side to an image side, a first lens element, a second lens element, a third lens element, a fourth lens element, a fifth lens element, a sixth lens element, a seventh lens element, and an eighth lens element arranged along an optical axis. Each lens element has an object-side surface facing toward the object side and an image-side surface facing toward the image side. The first lens element has a negative refractive power, the object-side surface of the first lens element has a convex portion in a vicinity of an outer circumference and the image-side surface of the first lens element has a concave portion in a vicinity of an optical axis. The second lens element is made of plastic. The third lens element has a refractive power. The object-side surface of the fourth lens element has a concave portion in the vicinity of the optical axis and the image-side surface has a concave portion in the vicinity of the optical axis. The object-side surface of the fifth lens element has a convex portion in the vicinity of the optical axis. The object-side surface of the sixth lens element has a convex portion in the vicinity of the optical axis and the image-side surface has a convex portion in the vicinity of the optical axis. The seventh lens element has a refractive power. The eighth lens element has a positive refractive power, the object-side surface of the eighth lens element has a convex portion in the vicinity of the optical axis and a convex portion in the vicinity of the outer circumference. The optical imaging lens only has eight lens elements having a refractive power.

In another embodiment, an optical imaging lens includes, in order from an object side to an image side, a first lens element, a second lens element, a third lens element, a fourth lens element, a fifth lens element, a sixth lens element, a seventh lens element, and an eighth lens element arranged along an optical axis. Each lens element has an object-side surface facing toward the object side and an image-side surface facing toward the image side. The object-side surface of the first lens element has a convex portion in a vicinity of an optical axis and the image-side surface of the first lens element has a concave portion in the vicinity of the optical axis. The second lens element has a refractive power. The third lens element is made of plastic. The fourth lens element has a negative refractive power, the object-side surface of the fourth lens element has a concave portion in the vicinity of the optical axis. The fifth lens element has a positive refractive power, the object-side surface of the fifth lens element has a convex portion in the vicinity of the optical axis. The object-side surface of the sixth lens element has a convex portion in the vicinity of the outer circumference and the image-side surface of the sixth lens element has a convex portion in the vicinity of the optical axis. The seventh lens element has a refractive power. The object-side surface of the eighth lens element has a convex portion in the vicinity of the optical axis and the image-side surface of the eighth lens element has a convex portion in the vicinity of the optical axis. The optical imaging lens only has eight lens elements having a refractive power.

In yet another embodiment, an optical imaging lens includes, in order from an object side to an image side, a first lens element, a second lens element, a third lens element, a fourth lens element, a fifth lens element, a sixth lens element, a seventh lens element, and an eighth lens element arranged along an optical axis. Each lens element has an object-side surface facing toward the object side and an image-side surface facing toward the image side. The image-side surface of the first lens element has a concave portion in a vicinity of an optical axis and a concave portion in a vicinity of an outer circumference. The second and third lens elements have a refractive power. The object-side surface of the fourth lens element has a concave portion in the vicinity of the optical axis and a concave portion in the vicinity of the outer circumference. The fifth lens element has a positive refractive power, the object-side surface of the fifth lens element has a convex portion in the vicinity of the outer circumference. The sixth lens element has a positive refractive power, the image-side surface of the sixth lens element has a convex portion in the vicinity of the optical axis and a convex portion in the vicinity of the outer circumference. The seventh lens element is made of plastic. The object-side surface of the eighth lens element has a convex portion in the vicinity of the optical axis and a convex portion in the vicinity of the outer circumference. The optical imaging lens only has eight lens elements having a refractive power. Some or all of the lens elements can be made of plastic.

The following description, together with the accompanying drawings, will provide a better understanding of the nature and advantages of the claimed invention.

### BRIEF DESCRIPTION OF THE DRAWINGS

FIG. 1 is a cross-sectional view of an optical imaging lens according to a first embodiment of the present invention;

FIG. 2 is a cross-sectional view of an optical imaging lens according to a second embodiment of the present invention;

FIG. 3 is a cross-sectional view of an optical imaging lens according to a third embodiment of the present invention;

FIG. 4 is a cross-sectional view of an optical imaging lens according to a fourth embodiment of the present invention;

FIG. 5 is a cross-sectional view of an optical imaging lens according to a fifth embodiment of the present invention;

FIG. 6 shows optical characteristics of respective aberrations, astigmatic curves and distortions according to the first embodiment of the present invention;

FIG. 7 shows optical characteristics of respective aberrations, astigmatic curves and distortions according to the second embodiment of the present invention;

FIG. 8 shows optical characteristics of respective aberrations, astigmatic curves and distortions according to the third embodiment of the present invention;

FIG. 9 shows optical characteristics of respective aberrations, astigmatic curves and distortions according to the fourth embodiment of the present invention; and

FIG. 10 shows optical characteristics of respective aberrations, astigmatic curves and distortions according to the fifth embodiment of the present invention.

### DETAILED DESCRIPTION

It should be understood that the drawings are not drawn to scale, and similar reference numbers are used for representing similar elements. As used herein, the terms “example embodiment,” “exemplary embodiment,” and “present embodiment” do not necessarily refer to a single embodiment, although it may, and various example embodiments may be readily combined and interchanged, without departing from the scope or spirit of the present invention.

In the present specification, “a lens element having positive refractive power (or negative refractive power)” means that the lens element has positive refractive power (or negative refractive power) in the vicinity of the optical axis. “An object-side (or image-side) surface of a lens element comprises a convex (or concave) portion in a specific region” means that the object-side (or image-side) surface of the lens element “protrudes outwardly (or depresses inwardly)” along the direction parallel to the optical axis at the specific region, compared with the outer region radially adjacent to the specific region. The “effective diameter” (also sometimes referred to as “clear aperture diameter” or “clear aperture”) of a lens element refers to the diameter of the portion of the surface of the lens element that is shaped to contribute to optical performance. For example, some or all lens elements may be formed with a flange or other structure at the outer periphery for mechanical purposes (e.g., positioning and retention of the lens element), and it is to be understood that such a structure would be outside the effective diameter. Further, in some instances, the object-side and image-side surfaces of a single lens element may have different effective diameters. In some instances, portions of the surface of a lens element may be specified as convex or concave. Such portions can be symmetric about the optical axis, with a portion that is “near,” or “in the vicinity of,” the optical axis extending outward from the optical axis and a portion “near,” or “in the vicinity of,” the periphery extending inward from the effective diameter. Those skilled in the art will understand that a portion of the surface described as being near the optical axis (or near the peripheral edge) may extend outward (or inward) sufficiently far to provide the desired optical properties.

Certain embodiments of the present invention relate to eight-element optical imaging lenses that have broad applications in portable and wearable electronic devices, such as mobile phones, digital still cameras, digital video cameras, tablet PCs, and the like, that use a CCD or a CMOS imaging sensor. Lens data and other parameters of optical imaging lenses according to specific embodiments are described below. Those skilled in the art with access to the present disclosure will recognize that other optical imaging lenses can also be designed within the scope of the claimed invention.

### First Embodiment

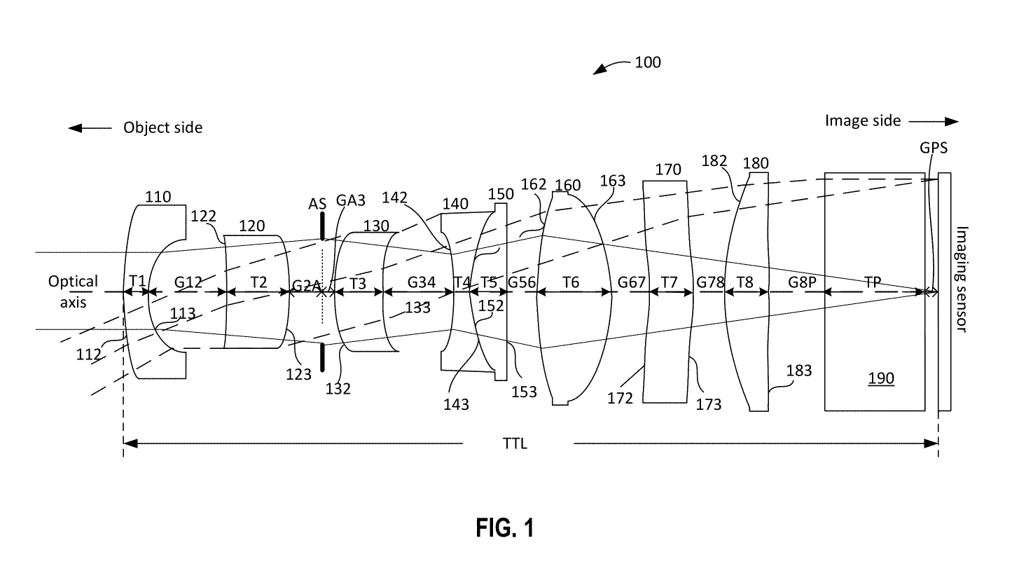

FIG. 1 is a cross-sectional view of an imaging lens 100 according to a first embodiment of the present invention. Imaging lens 100 includes a first lens element 110, a second lens element 120, a third lens element 130, a fourth lens element 140, a fifth lens element 150, a sixth lens element 160, a seventh lens element 170, an eight lens element 180, in this order from the object side to the image side along the optical axis. An optical aperture stop AS is disposed on the object side of lens element 130. Specifically, aperture stop AS is disposed between second and third lens elements 120 and 130.

First lens element 110 has a negative refractive power, a convex surface 112 on the object-side, and a concave surface 113 on the image side. Second lens element 120 has an even-aspheric object-side surface 122 and an even-aspheric image-side surface 123. Third lens element 130 has an even-aspheric object-side surface 132 and an even-aspheric image-side surface 133. Lens element 140 has a spherical object-side surface 142 and a spherical image-side surface 143. Lens element 150 has a spherical object-side surface 152 and a spherical image-side surface 153. Object-side surface 152 of lens element 150 has a surface area abutted to a surface area of image side surface 143 of lens element 140. Lens element 160 is a double convex lens having an even-aspheric convex surface 162 on the object-side and an even-aspheric convex surface 163 on the image side. Lens element 170 has an even-aspheric object-side surface 172 and an even-aspheric surface 173 on the image side. Lens element 180 has an even-aspheric object-side surface 182 and an even-aspheric surface 183 on the image side.

The lens elements can be made of different materials. In some embodiments, the eight lens elements are made of plastic. In other embodiments, some of them may be made of glass. In a specific embodiment, lens element 110 is made of plastic, lens element 120 is made of glass, lens element 130 is made of plastic, lens elements 140 and 150 are made of glass, lens elements 160, 170 and 180 are made of plastic.

In some embodiments, lens 100 further includes a color separation prism 190. Color separation prism 190 may be of X-cube type or a Philips prism. Examples of suitable prisms are described in “Polarization Engineering for LCD Projection” by Michael D. Robinson, Gary Sharp, and Jianmin Chen, which is incorporated by reference herein. US Publication 201300 63629A1 also provides description of prisms and is incorporated herein by reference.

Table 1 shows numeric lens data of imaging lens 100 according to an embodiment of the present invention.

TABLE 1

| | surface | curvature | thickness/air | semi-diameter | lens | refractive | Abbe |
|---|---|---|---|---|---|---|---|
| surface | type | radius (mm) | gap (mm) | (mm) | element | index | number |
| 112 | even | 8.295 | T1 = 0.8 | 2.566 | 110 | 1.54 | 56.1 |
| | aspheric | | | | | | |
| 113 | even | 1.999 | G12 = 2.207 | 1.769 | | | |
| | aspheric | | | | | | |
| 122 | even | −14.119 | T2 = 1.710 | 1.649 | 120 | 1.73 | 54.5 |
| | aspheric | | | | | | |
| 123 | even | −4.824 | G2A = 0.100 | 1.679 | | | |
| | aspheric | | GA3 = 0.400 | | | | |
| 132 | even | 4.325 | T3 = 1.423 | 1.768 | 130 | 1.64 | 23.3 |
| | aspheric | | | | | | |
| 133 | even | 9.830 | G34 = 1.339 | 1.715 | | | |
| | aspheric | | | | | | |
| 142 | spherical | −4.507 | T4 = 0.541 | 1.859 | 140 | 1.81 | 25.3 |
| 143 | spherical | 4.337 | T5 = 1.000 | 2.382 | | | |
| 153 | spherical | 50.687 | G56 = 0.099 | 2.536 | 150 | 1.69 | 53.3 |
| 162 | even | 8.306 | T6 = 2.102 | 2.998 | 160 | 1.51 | 56.8 |
| | aspheric | | | | | | |
| 163 | even | −4.188 | G67 = 0.1 | 3.122 | | | |
| | aspheric | | | | | | |
| 172 | even | −13.988 | T7 = 1.3 | 3.255 | 170 | 1.64 | 23.3 |
| | aspheric | | | | | | |
| 173 | even | −26.314 | G78 = 0.099 | 3.339 | | | |
| | aspheric | | | | | | |
| 182 | even | 7.072 | T8 = 1.3 | 3.462 | 180 | 1.52 | 56.1 |
| | aspheric | | | | | | |
| 183 | even | −20.972 | G8P = 0.2 | 3.438 | | | |
| | aspheric | | | | | | |
| 190 | spherical | | TP = 7.000 | 290 | | 1.52 | 64.2 |

Referring to FIG. 1 and Table 1, T1 is a thickness of first lens element 110 that is measured from the object-side surface at the optical axis to the image-side surface at the optical axis. Similarly, T2 is a thickness of second lens element 120 measured at the optical axis, T3 is a thickness of third lens element 130 measured at the optical axis, T4 is a thickness of fourth lens element 140 measured at the optical axis, T5 is a thickness of fifth lens element 150 measured at the optical axis, T6 is a thickness of sixth lens element 160 measured at the optical axis, T7 is a thickness of seventh lens element 170 measured at the optical axis, T8 is a thickness of eighth lens element 180 measured at the optical axis, and TP is a thickness of prism 190 measured at the optical axis. G12 is an air gap between the image-side surface of first lens element 110 and the object-side surface of second lens element 120 along the optical axis, G2A is an air gap between the image-side surface of second lens element 120 and aperture stop AS, GA3 is an air gap between aperture stop AS and the object-side surface of third lens element 130 along the optical axis, i.e., the air gap G23 between the image-side surface of second lens element 120 and the object-side surface of third lens element 130 along the optical axis is the sum of G2A and GA3. G34 is an air gap between the image-side surface of third lens element 130 and the object-side surface of fourth lens element 140 along the optical axis, G56 is an air gap between the image-side surface of fifth lens element 150 and the object-side surface of sixth lens element 160 along the optical axis, G67 is an air gap between the image-side surface of sixth lens element 160 and the object-side surface of seventh lens element 170 along the optical axis, and G78 is an air gap between the image-side surface of seventh lens element 170 and the object-side surface of seventh lens element 180 along the optical axis. Similarly, G8P is an air gap between the image-side surface of eighth lens element 180 and the object-side surface of prism 190 along the optical axis. No air gap exists between the fourth and fifth lens elements. TTL is a distance measured from the object-side surface of first lens element 110 to an object-side surface of an imaging sensor. (These parameter names will also be used for the following second through fourth embodiments.)

In some embodiments, the distance between the object side surface 132 and aperture stop AS is in a range between 0.36 mm and 0.44 mm, and the semi-diameter of aperture stop AS is in the range between 1.2 mm and 1.6 mm. In a specific embodiment, the distance between the aperture stop AS and the object-side surface of the third lens element 130 is 0.40 mm and the semi-diameter of the aperture stop AS is 1.400 mm. In some embodiments, color separation prism 190 has a thickness in the range between 5 mm and 9 mm and a semi-diameter in the range between 3.2 mm and 3.6 mm. In a specific embodiment, the thickness of the color separation prism 190 is about 7 mm, and the semi-diameter is about 3.404 mm.

In some embodiments, the even aspheric surface of the lens elements can be expressed using the following expression:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} . \qquad ( 1 )$$

where z is the depth of the aspheric surface, r is the distance (height) in millimeters (mm) from the optical axis to the lens surface, k is a conic constant, and αᵢ is the i-th degree (or order term) aspheric surface coefficient.

Table 2 shows numeric values of the aspheric lens elements, which can be used with Eq. (1) to characterize various surfaces of the lens elements.

TABLE 2

| Lens element | surface | Conic constant | 4-th order term | 6-th order term | 8-th order term |
|---|---|---|---|---|---|
| 110 | 112 | 0 | 2.3351E−03 | −6.5274E−05 | −4.4471E−06 |
| | 113 | 0 | −3.0317E−04 | | |
| 120 | 122 | 0 | −5.0735E−03 | | |
| | 123 | 0 | −5.4794E−03 | −3.7933E−04 | 0.0000E+00 |
| 130 | 132 | 2.319975332 | 1.9047E−03 | −6.2552E−04 | −7.6542E−05 |
| | 133 | 2.179079157 | 1.1881E−02 | 0.0000E+00 | 0.0000E+00 |
| 160 | 162 | 0 | −1.1843E−03 | | |
| | 163 | −1.813978914 | −2.4460E−03 | | |
| 170 | 172 | 0 | 1.8638E−03 | | |
| | 173 | −9.830294607 | 1.1205E−03 | | |
| 180 | 182 | 0 | −7.8492E−04 | −4.7790E−06 | |
| | 183 | 0 | 1.0187E−03 | | |

Table 3 shows the focal length (in mm) of the lens elements of the first embodiment.

TABLE 3

| Lens element | 110 | 120 | 130 | 140 | 150 | 160 | 170 | 180 |
|---|---|---|---|---|---|---|---|---|
| Focal length | −5.063 | 9.313 | 10.930 | −2.650 | 6.768 | 5.731 | −48.525 | 9.867 |

In some embodiments, the effective focal length of the first embodiment is 4.30 mm to 4.35 mm. The half field of view is 34 degrees. The F number is 2.4. The thickness of the prismatic lens 190 is about 7 mm and the distance between 190 and an image plane is 0.703 mm. The TTL (distance from the first lens element to the image plane on the optical axis) is 22.4 mm. The chief ray angle (CRA) is in a range between 1 degree and 5 degrees, preferably about 1.99 degrees. The combined focal length of lens elements 160, 170, and 180 is from 4.388 mm to 4.637 mm.

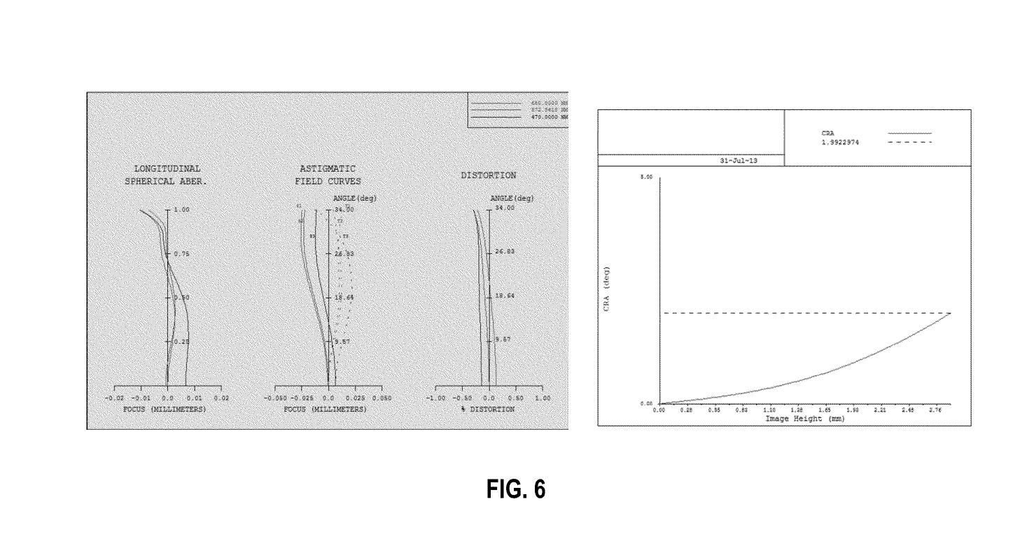

FIG. 6 shows optical characteristics of respective aberrations, astigmatic curves, distortions, and chief ray angle according the first embodiment of the present invention.

### Second Embodiment

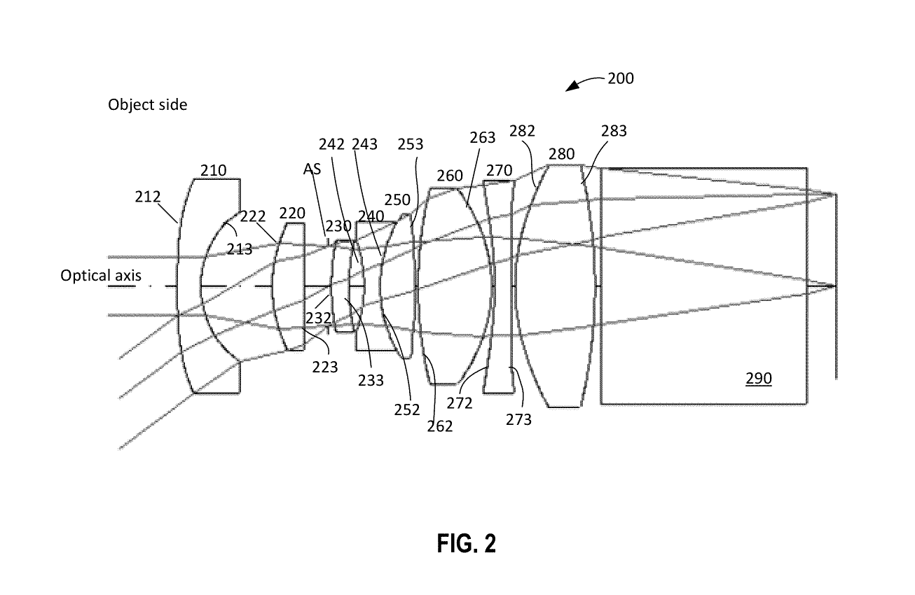

FIG. 2 is a cross-sectional view of an optical imaging lens 200 according to a second embodiment of the present invention. Imaging lens 200 includes a first lens element 210, a second lens element 220, a third lens element 230, a fourth lens element 240, a fifth lens element 250, a sixth lens element 260, a seventh lens element 270, an eight lens element 280, in this order from the object side to the image side along the optical axis. An optical aperture stop AS is disposed on the object side of lens element 230. Specifically, aperture stop AS is disposed between second and third lens elements 220 and 230.

First lens element 210 has a convex surface 212 on the object side and a concave surface 213 on the image side in the vicinity of the optical axis. Second lens element 220 has a convex object side surface 222 and an image side surface 223 which has a concave shape on the optical axis and a convex shape around the periphery. Third lens element 230 has an even-aspheric object-side surface 232 and an even-aspheric image-side surface 233. Lens element 240 has a spherical object-side surface 242 and a spherical image-side surface 243. Lens element 250 has a spherical object-side surface 252 and a spherical image-side surface 253. Object-side surface 252 of lens element 250 has a surface area abutted to a surface area of image-side surface 143 of lens element 240. Lens element 260 is a double convex lens having an even-aspheric convex surface 262 on the object side and an even-aspheric convex surface 263 on the image side. Lens element 270 has an even-aspheric object-side surface 272 and an even-aspheric surface 273 on the image side. Lens element 280 has an even-aspheric object-side surface 282 and an even-aspheric surface 283 on the image side.

The lens elements can be made of different materials. In some embodiments, one or more of them may be made of glass. In a specific embodiment, lens elements 210, 220, 230, 260, 270 and 280 are made of plastic, and lens elements 240 and 250 are made of glass.

In some embodiments, optical imaging lens 200 further includes a color separation prism 290 disposed between eighth lens element and an imaging sensor. Prism 290 can be similar to prism 190 described above.

Table 4 shows numeric lens data of optical imaging lens 200 according to an embodiment of the present invention.

TABLE 4

| | surface | curvature | thickness/air | Lens | refractive | Abbe |
|---|---|---|---|---|---|---|
| surface | type | radius (mm) | gap (mm) | element | index | number |
| 212 | even | 24.992 | T1 = 0.8 | 210 | 1.54 | 56.1 |
| | aspheric | | | | | |
| 213 | even | 2.666 | G12 = 2.424 | | | |
| | aspheric | | | | | |
| 222 | even | 3.749 | T2 = 1.100 | 220 | 1.64 | 23.3 |
| | aspheric | | | | | |
| 223 | even | 42.199 | G2A = 0.813 | | | |
| | aspheric | | GA3 = 0.1 | | | |
| 232 | even | 6.815 | T3 = 0.600 | 230 | 1.64 | 23.3 |
| | aspheric | | | | | |
| 233 | even | 6.493 | G34 = 0.508 | | | |
| | aspheric | | | | | |
| 242 | spherical | −4.166 | T4 = 0.550 | 240 | 1.75 | 27.6 |
| 243 | spherical | 3.699 | T5 = 1.184 | | | |
| 253 | spherical | −17.482 | G56 = 0.100 | 250 | 1.65 | 53.0 |
| 262 | even | 11.308 | T6 = 2.500 | 260 | 1.51 | 56.8 |
| | aspheric | | | | | |
| 263 | even | −4.301 | G67 = 0.100 | | | |
| | aspheric | | | | | |
| 272 | even | −10.728 | T7 = 0.6 | 270 | 1.64 | 23.3 |
| | aspheric | | | | | |
| 273 | even | −36.389 | G78 = 0.100 | | | |
| | aspheric | | | | | |
| 282 | even | 5.936 | T8 = 2.711 | 280 | 1.54 | 56.1 |
| | aspheric | | | | | |
| 283 | even | −14.516 | G8P = 0.200 | | | |
| | aspheric | | | | | |
| 290 | spherical | | TP = 7.000 | 290 | 1.52 | 64.2 |

Table 5 shows numeric values of the aspheric lens elements of the second embodiment. These values can be used in combination with Eq. (1) above to characterize the lens surfaces.

TABLE 5

| Lens element | surface | Conic constant | 4-th order term | 6-th order term | 8-th order term |
|---|---|---|---|---|---|
| 210 | 212 | 0 | 3.48929E−03 | −1.09889E−04 | 4.14356E−06 |
| | 213 | 0 | −9.64950E−04 | 0 | 0 |
| 220 | 222 | 0 | −3.24925E−03 | 0 | 0 |
| | 223 | 0 | −3.06236E−03 | −9.64044E−05 | 0.0000E+00 |
| 230 | 232 | 2.31275E+00 | 4.32668E−05 | 1.07395E−03 | −2.29433E−04 |
| | 233 | −2.09719E+01 | 1.14068E−02 | 0.0000E+00 | 0.0000E+00 |
| 260 | 262 | 0 | −8.18803E−05 | 0 | 0 |
| | 263 | −1.81398E+00 | −2.20368E−03 | 0 | 0 |
| 270 | 272 | 0 | 1.08739E−03 | 0 | 0 |
| | 273 | −9.83029E+00 | 1.92072E−03 | 0 | 0 |
| 280 | 282 | 0 | 2.31252E−05 | −1.83743E−05 | 0 |
| | 283 | 0 | 2.31252E−05 | 0 | 0 |

Table 6 shows the focal length (in mm) of the lens elements of the second embodiment.

TABLE 6

| Lens element | 210 | 220 | 230 | 240 | 250 | 260 | 270 | 280 |
|---|---|---|---|---|---|---|---|---|
| Focal length | −5.547 | 6.340 | −788.36 | −2.511 | 4.807 | 6.395 | −23.919 | 8.111 |

In some embodiments, the effective focal length is 4.35 mm. The half field of view is 34 degrees. The F number is 2.4. The thickness of the prismatic lens 190 is about 7 mm and the distance between 190 and an image plane is 1.01 mm. The TTL (distance from the first lens element to the image plane on the optical axis) is 22.4 mm. The chief ray angle (CRA) is 2.02 degrees. The combined focal length of lens elements 260, 270, and 280 is 4.636 mm.

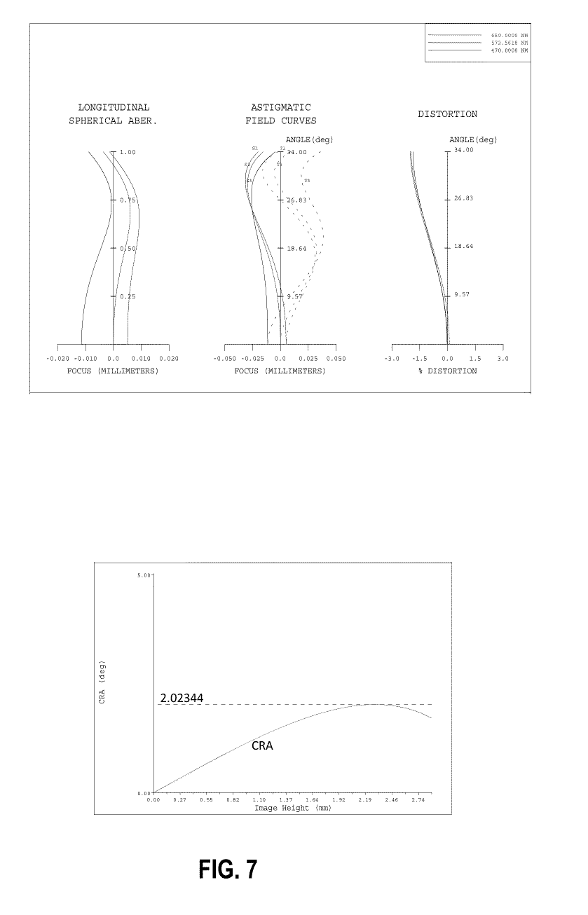

FIG. 7 shows optical characteristics of respective aberrations, astigmatic curves, distortions, and chief ray angle according the second embodiment of the present invention.

### Third Embodiment

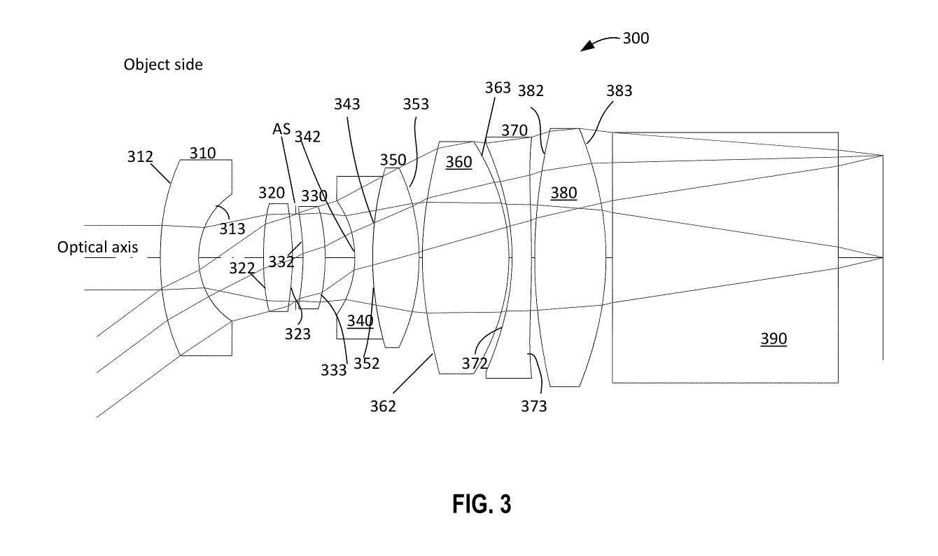

FIG. 3 is a cross-sectional view of an optical imaging lens 300 according to a third embodiment of the present invention. Optical imaging lens 300 includes a first lens element 310, a second lens element 320, a third lens element 330, a fourth lens element 340, a fifth lens element 350, a sixth lens element 360, a seventh lens element 370, an eighth lens element 380, in this order from the object side to the image side along the optical axis. An optical aperture stop AS is disposed on the object side of lens element 330. Specifically, aperture stop AS is disposed between second and third lens elements 320 and 330.

First lens element 310 has an even-aspheric convex surface 312 on the object side and an even-aspheric concave surface 313 on the image side. Second lens element 320 has a convex object-side surface 322 and a convex image-side surface 323. Third lens element 330 has an even aspheric object-side surface 332 and an even-aspheric image-side surface 333. Lens element 340 has a spherical object-side surface 342 and a spherical image-side surface 343. Lens element 350 has a spherical object-side surface 352 and a spherical image-side surface 353. Object-side surface 352 of lens element 350 has a surface area abutted to a surface area of image-side surface 343 of lens element 340. Lens element 360 is a double convex lens having an even-aspheric convex surface 362 on the object side and an even-aspheric convex surface 363 on the image side. Lens element 370 has an even-aspheric object-side surface 372 and an even-aspheric surface 373 on the image side. Lens element 380 has an even-aspheric object-side surface 382 and an even-aspheric surface 383 on the image side.

The lens elements can be made of different materials. In some embodiments, one or more of them may be made of glass, and some of them are made of plastic. In a specific embodiment, lens elements 310, 320, 330, 360, 370 and 380 are made of plastic, and lens elements 340 and 350 are made of glass.

In an embodiment, optical imaging lens 300 further includes a color separation prism 390 disposed between eighth lens element 380 and an imaging sensor.

Table 7 shows numeric lens data of optical imaging lens 300 according to an embodiment of the present invention.

TABLE 7

| | | curvature | thickness/air | lens | refractive | Abbe |
|---|---|---|---|---|---|---|
| surface | type | radius (mm) | gap (mm) | element | index | number |
| 312 | even | 8.116 | T1 = 1.188 | 310 | 1.54 | 56.1 |
| | aspheric | | | | | |
| 313 | even | 2.161 | G12 = 2.009 | | | |
| | aspheric | | | | | |
| 322 | even | 8.760 | T2 = 0.897 | 320 | 1.64 | 23.3 |
| | aspheric | | | | | |
| 323 | even | −6.169 | G2A = 0.100 | | | |
| | aspheric | | GA3 = 0.228 | | | |
| 332 | even | −5.607 | T3 = 0.683 | 330 | 1.64 | 23.3 |
| | aspheric | | | | | |
| 333 | even | −5.650 | G34 = 0.921 | | | |
| | aspheric | | | | | |
| 342 | spherical | −2.556 | T4 = 0.550 | 340 | 1.75 | 27.6 |
| 352 | spherical | 8.268 | T5 = 1.444 | | | |
| 353 | spherical | −5.401 | G56 = 0.100 | 350 | 1.74 | 44.9 |
| 362 | even | 8.560 | T6 = 2.681 | 360 | 1.54 | 56.1 |
| | aspheric | | | | | |
| 363 | even | −5.032 | G67 = 0.100 | | | |
| | aspheric | | | | | |
| 372 | even | −6.004 | T7 = 0.600 | 370 | 1.64 | 23.3 |
| | aspheric | | | | | |
| 373 | even | −26.555 | G78 = 0.100 | | | |
| | aspheric | | | | | |
| 382 | even | 12.443 | T8 = 2.208 | 380 | 1.54 | 56.1 |
| | aspheric | | | | | |
| 383 | even | −7.657 | G8P = 0.200 | | | |
| | aspheric | | | | | |
| 390 | spherical | | TP = 7.000 | 390 | 1.52 | 64.2 |

Table 8 shows numeric values of the aspheric lens elements of the third embodiment. These values can be used in combination with Eq. (1) above to characterize the lens surfaces.

TABLE 8

| Lens element | surface | Conic constant | 4-th order term | 6-th order term | 8-th order term |
|---|---|---|---|---|---|
| 310 | 312 | 0 | 4.43757E−03 | −3.64161E−04 | 1.09712E−05 |
| | 313 | 0 | 8.51695E−03 | 0 | 0 |
| 320 | 322 | 0 | 6.09186E−03 | 1.06434E−03 | 0 |
| | 323 | 0 | 8.83465E−03 | 0 | 0.0000E+00 |
| 330 | 332 | −1.12702E+01 | −9.43833E−04 | 0 | 0 |
| | 333 | 1.93571E+00 | −4.76973E−03 | −4.31664E−04 | 2.01780E−04 |
| 360 | 362 | 0 | −1.05297E−03 | 0 | 0 |
| | 363 | −1.81398E+00 | −9.80693E−04 | 0 | 0 |
| 370 | 372 | 0 | 1.14880E−03 | 0 | 0 |
| | 373 | −9.83029E+00 | 1.64008E−03 | 0 | 0 |
| 380 | 382 | 0 | −6.10215E−04 | 2.12705E−05 | 0 |
| | 383 | 0 | 5.09794E−04 | 0 | 0 |

Table 9 shows the focal length (in mm) of the eight lens elements of the third embodiment.

TABLE 9

| Lens element | 310 | 320 | 330 | 340 | 350 | 360 | 370 | 380 |
|---|---|---|---|---|---|---|---|---|
| Focal length | −5.815 | 5.775 | 220.75 | −2.523 | 4.590 | 6.251 | −12.226 | 9.050 |

In some embodiments, the effective focal length is 4.35 mm. The half field of view is 34 degrees. The F number is 2.4. The thickness of prismatic lens 390 is about 7 mm and the distance between 190 and an image plane is 1.39 mm. The air gap between the aperture stop AS and the object-side surface of third lens element 330 along the optical axis is 0.228 mm. The TTL (distance from the first lens element to the image plane on the optical axis) is 22.4 mm. The chief ray angle (CRA) is 2.02 degrees. The combined focal length of lens elements 360, 370, and 380 is 4.636 mm.

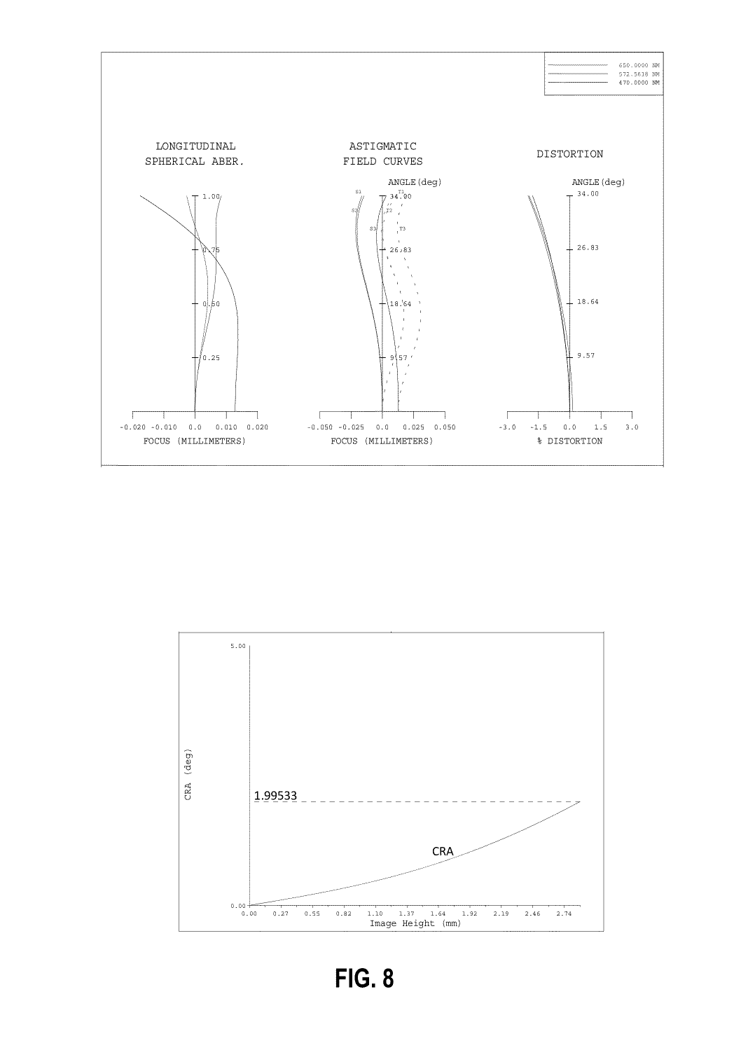

FIG. 8 shows optical characteristics of respective aberrations, astigmatic curves, distortions and chief ray angle according to the third embodiment of the present invention.

### Fourth Embodiment

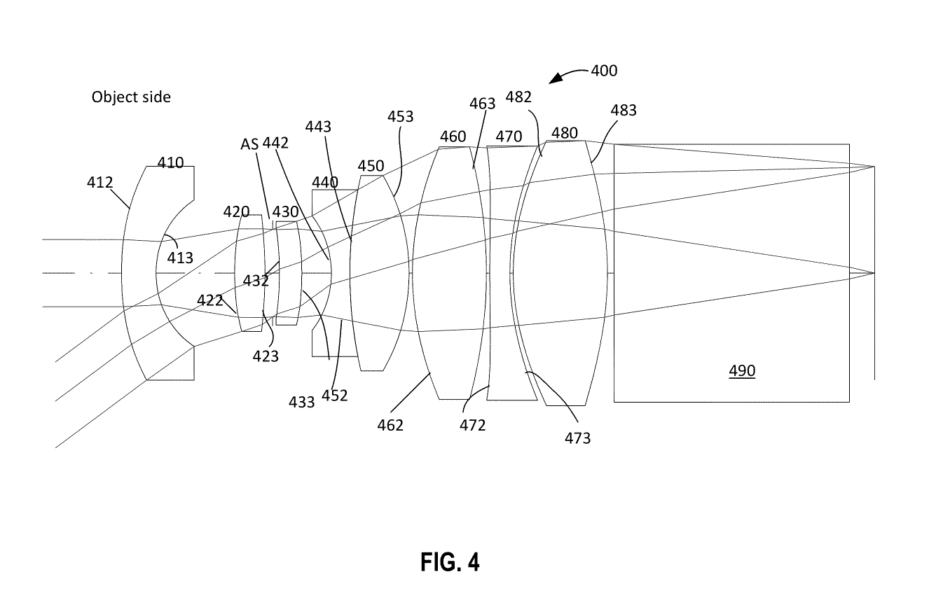

FIG. 4 is a cross-sectional view of an optical imaging lens 400 according to a fourth embodiment of the present invention. Imaging lens 400 includes a first lens element 410, a second lens element 420, a third lens element 430, a fourth lens element 440, a fifth lens element 450, a sixth lens element 460, a seventh lens element 470, an eight lens element 480, in this order from the object side to the image side along the optical axis. An optical aperture stop AS is disposed on the object side of lens element 430. Specifically, aperture stop AS is disposed between second and third lens elements 420 and 430.

First lens element 410 has an even-aspheric convex surface 412 on the object side and an even-aspheric convex surface 413 on the image side. Second lens element 420 has an even-aspheric object-side surface 422 and an even-aspheric image-side surface 423. Third lens element 430 has an even-aspheric object-side surface 432 and an even-aspheric image-side surface 433. Lens element 440 has a spherical object-side surface 442 and a spherical image-side surface 443. Lens element 450 has a spherical object-side surface 452 and a spherical image-side surface 453. Object-side surface 452 of lens element 450 has a surface area abutted to a surface area of image side surface 443 of lens element 440. Lens element 460 is a double convex lens having an even-aspheric convex surface 462 on the object side and an even-aspheric convex surface 363 on the image side. Lens element 470 has an even-aspheric object-side surface 472 and an even-aspheric surface 473 on the image side. Lens element 480 has an even-aspheric object-side surface 482 and an even-aspheric surface 483 on the image side.

The lens elements can be made of different materials. In some embodiments, one or more of them may be made of glasses, and some of them are made of plastic. In a specific embodiment, lens elements 410, 420, 430, 460, 470 and 480 are made of plastic, and lens elements 440 and 450 are made of glass.

In an embodiment, lens 400 further includes a color separation prism 490 disposed between eighth lens element 480 and an imaging sensor. Prism 490 can be similar to prism 190 described above.

Table 10 shows numeric lens data of imaging lens 400 according to an embodiment of the present invention.

TABLE 10

| | | curvature | thickness/air | lens | refractive | Abbe |
|---|---|---|---|---|---|---|
| surface | type | radius (mm) | gap (mm) | element | index | number |
| 412 | even | 7.265 | T1 = 1.028 | 410 | 1.54 | 56.1 |
| | aspheric | | | | | |
| 413 | even | 2.382 | G12 = 2.338 | | | |
| | aspheric | | | | | |
| 422 | even | 7.098 | T2 = 0.901 | 420 | 1.64 | 23.3 |
| | aspheric | | | | | |
| 423 | even | −10.625 | G2A = 0.232 | | | |
| | aspheric | | GA3 = 0.199 | | | |
| 432 | even | −7.778 | T3 = 0.666 | 430 | 1.64 | 23.3 |
| | aspheric | | | | | |
| 433 | even | −7.467 | G34 = 0.878 | | | |
| | aspheric | | | | | |
| 442 | spherical | −2.362 | T4 = 0.550 | 440 | 1.74 | 27.6 |
| 452 | spherical | 10.655 | T5 = 1.762 | | | |
| 453 | spherical | −4.845 | G56 = 0.100 | 450 | 1.74 | 44.9 |
| 462 | even | 7.134 | T6 = 2.200 | 460 | 1.54 | 56.1 |
| | aspheric | | | | | |
| 463 | even | −11.333 | G67 = 0.100 | | | |
| | aspheric | | | | | |
| 472 | even | 48.937 | T7 = 0.600 | 470 | 1.64 | 23.3 |
| | aspheric | | | | | |
| 473 | even | 6.674 | G78 = 0.100 | | | |
| | aspheric | | | | | |
| 482 | even | 5.952 | T8 = 2.800 | 480 | 1.54 | 56.1 |
| | aspheric | | | | | |
| 483 | even | −8.419 | G8P = 0.200 | | | |
| | aspheric | | | | | |
| 490 | spherical | | TP = 7.000 | 490 | 1.51 | 64.2 |

Table 11 shows numeric values of the aspheric lens elements of the fourth embodiment. These values can be used in combination with Eq. (1) above to characterize the lens surfaces.

TABLE 11

| Lens element | surface | Conic constant | 4-th order term | 6-th order term | 8-th order term |
|---|---|---|---|---|---|
| 410 | 412 | 0 | 3.69940E−03 | −2.31167E−04 | 5.47303E−06 |
| | 413 | 0 | 5.72955E−03 | 0 | 0 |
| 420 | 422 | 0 | 4.83110E−03 | 6.62477E−04 | 0 |
| | 423 | 0 | 3.08042E−03 | 0 | 0.0000E+00 |
| 430 | 432 | −9.19024E+00 | −2.64581E−03 | 0 | 0 |
| | 433 | 4.66632E+00 | −6.12824E−03 | −1.88176E−04 | 7.35990E−05 |
| 460 | 462 | 0 | −4.88916E−04 | 0 | 0 |
| | 463 | 0 | 2.80838E−04 | −1.10720E−05 | 0 |
| 470 | 472 | −9.83029E+00 | −1.50798E−03 | 0 | 0 |
| | 473 | −0 | −9.09530E−04 | 0 | 0 |
| 480 | 482 | −1.81398E+00 | −1.08729E−04 | 0 | 0 |
| | 483 | 0 | 8.05219E−04 | 0 | 0 |

Table 12 shows the focal length (in mm) of the lens elements of the fourth embodiment.

TABLE 12

| Lens element | 410 | 420 | 430 | 440 | 450 | 460 | 470 | 480 |
|---|---|---|---|---|---|---|---|---|
| Focal length | −7.024 | 6.764 | 158.32 | −2.557 | 4.697 | 8.387 | −12.107 | 6.872 |

In some embodiments, the effective focal length is 4.35 mm. The half field of view is 34 degrees. The F number is 2.4. The thickness of the prismatic lens 190 is about 7 mm and the distance between 190 and an image plane is 0.747 mm. The air gap between aperture stop AS and the object-side surface of third lens element along the optical axis is 0.199 mm. The TTL (distance from the first lens element to the image plane on the optical axis) is 22.4 mm. The chief ray angle (CRA) is 2.00 degrees. The combination of focal length of lens elements 460, 470, and 480 is 6.057 mm.

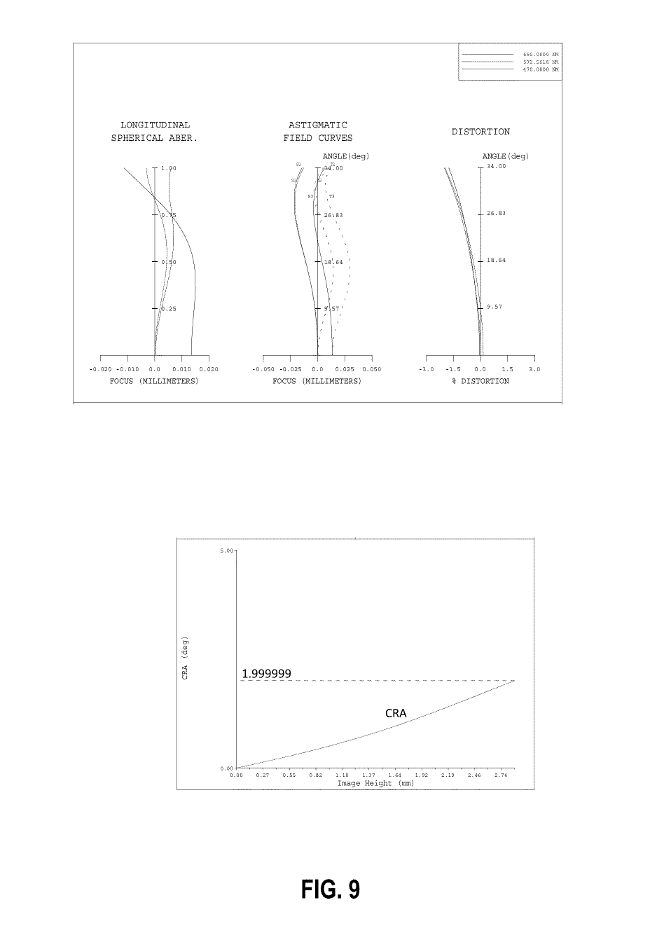

FIG. 9 shows optical characteristics of respective aberrations, astigmatic curves, distortions and chief ray angle according to the fourth embodiment of the present invention.

### Fifth Embodiment

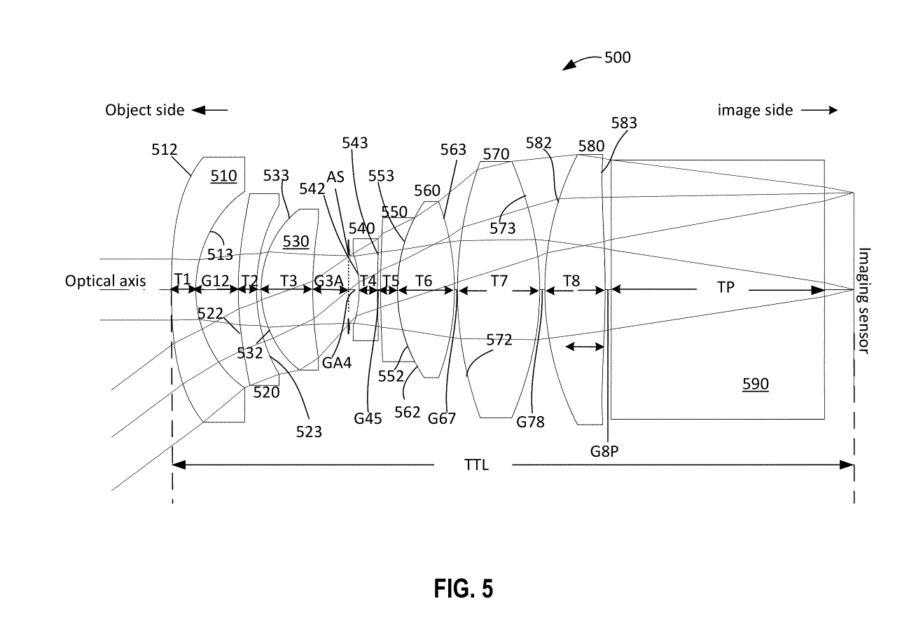

FIG. 5 is a cross-sectional view of an imaging lens 500 according to a fifth embodiment of the present invention. Imaging lens 500 includes a first lens element 510, a second lens element 520, a third lens element 530, a fourth lens element 540, a fifth lens element 550, a sixth lens element 560, a seventh lens element 570, an eighth lens element 580, in this order from the object side to the image side along the optical axis. An optical aperture stop AS is disposed on the object side of lens element 540. Specifically, aperture stop AS is disposed between third and fourth lens elements 530 and 540.

First lens element 510 has an even-aspheric convex surface 512 on the object side and an even aspheric convex surface 513 on the image side. Second lens element 520 has an even-aspheric object-side surface 522 and an even-aspheric image-side surface 523. Third lens element 530 has an even-aspheric object side surface 532 and an even-aspheric image-side surface 533. Lens element 540 has an even-aspheric object-side surface 542 and an even-aspheric image-side surface 543. Lens element 550 has a spherical object-side surface 552 and a spherical image-side surface 553. Lens element 560 is a double convex lens having a spherical convex surface 562 on the object side and a spherical convex surface 563 on the image side. Image side surface 553 of lens element 550 has a surface area abutted to a surface area of object-side surface 562 of lens element 560. Lens element 570 has an even-aspheric object-side surface 572 and an even-aspheric surface 573 on the image side. Lens element 580 has an even-aspheric object-side surface 582 and an even-aspheric surface 583 on the image side.

The lens elements can be made of different materials. In some embodiments, one or more of them may be made of glass, and some of them are made of plastic. In a specific embodiment, lens elements 510, 520, 530, 540, 570 and 580 are made of plastic, and lens elements 550 and 560 are made of glass.

In an embodiment, lens 500 further includes a color separation prism 590 disposed between eighth lens element 580 and an imaging sensor. Prism 590 can be similar to prism 190 described above.

Table 13 shows numeric lens data of imaging lens 500 according to an embodiment of the present invention.

TABLE 13

| | surface | curvature | thickness/air | Lens | refractive | Abbe |
|---|---|---|---|---|---|---|
| surface | type | radius (mm) | gap (mm) | element | index | number |
| 512 | even | 16.931 | T1 = 0.800 | 510 | 1.54 | 56.1 |
| | aspheric | | | | | |
| 513 | even | 3.283 | G12 = 1.396 | | | |
| | aspheric | | | | | |
| 522 | even | 8.732 | T2 = 0.600 | 520 | 1.54 | 56.1 |
| | aspheric | | | | | |
| 523 | even | 4.750 | G23 = 0.150 | | | |
| | aspheric | | | | | |
| 532 | even | 2.778 | T3 = 1.694 | 530 | 1.64 | 23.3 |
| | aspheric | | | | | |
| 533 | even | 10.926 | G3A = 1.208 | | | |
| | aspheric | | GA4 = 0.315 | | | |
| 542 | spherical | −3.358 | T4 = 0.600 | 540 | 1.64 | 23.3 |
| 543 | spherical | 15.240 | G45 = 0.107 | | | |
| 552 | spherical | 33.823 | T5 = 0.550 | 550 | 1.74 | 27.6 |
| 562 | even | 4.303 | T6 = 1.871 | 560 | 1.62 | 60.2 |
| | aspheric | | | | | |
| 563 | even | −6.795 | G67 = 0.100 | | | |
| | aspheric | | | | | |
| 572 | even | 9.953 | T7 = 2.700 | 570 | 1.54 | 56.1 |
| | aspheric | | | | | |
| 573 | even | −7.501 | G78 = 0.168 | | | |
| | aspheric | | | | | |
| 582 | even | 7.807 | T8 = 1.976 | 580 | 1.54 | 56.1 |
| | aspheric | | | | | |
| 583 | even | −26.527 | G8P = 0.200 | | | |
| | aspheric | | | | | |
| 590 | spherical | | TP = 7.000 | 590 | 1.52 | 64.2 |

Referring to FIG. 5 and Table 13, T1 is a thickness of first lens element 510 that is measured from the object-side surface at the optical axis to the image-side surface at the optical axis. Similarly, T2 is a thickness of second lens element 520 measured at the optical axis, T3 is a thickness of third lens element 530 measured at the optical axis, T4 is a thickness of fourth lens element 540 measured at the optical axis, T5 is a thickness of fifth lens element 550 measured at the optical axis, T6 is a thickness of sixth lens element 560 measured at the optical axis, T7 is a thickness of seventh lens element 570 measured at the optical axis, T8 is a thickness of eighth lens element 580 measured at the optical axis, and TP is a thickness of prism 590 measured at the optical axis. G12 is an air gap between the image-side surface of first lens element 510 and the object-side surface of second lens element 520 along the optical axis, G23 is an air gap between the image-side surface of second lens element 520 and the object-side surface of third lens element 530 along the optical axis, G3A is an air gap between the image-side surface of third lens element 530 and aperture stop AS, GA4 is an air gap between aperture stop AS and the object-side surface of fourth lens element 540 along the optical axis, i.e., the air gap G34 between the image-side surface of third lens element 530 and the object-side surface of fourth lens element 540 along the optical axis is the sum of G3A and GA4. G45 is an air gap between the image-side surface of fourth lens element 540 and the object-side surface of fifth lens element 550 along the optical axis, G67 is an air gap between the image-side surface of sixth lens element 560 and the object-side surface of seventh lens element 570 along the optical axis, and G78 is an air gap between the image-side surface of seventh lens element 570 and the object-side surface of eighth lens element 580 along the optical axis. Similarly, G8P is an air gap between the image-side surface of eighth lens element 580 and the object-side surface of prism 590 along the optical axis. No air gap exists between the fifth and sixth lens elements. TTL is a distance measured from the object-side surface of first lens element 510 to an object-side surface of an imaging sensor. (These parameters are defined consistently with definitions given above, with the differences being related to changes in the position of the aperture stop and the abutting lenses.)

Table 14 shows numeric values of the aspheric lens elements of the fifth embodiment. These values can be used in combination with Eq. (1) above to characterize the lens surfaces.

TABLE 14

| Lens element | surface | Conic constant | 4-th order term | 6-th order term | 8-th order term |
|---|---|---|---|---|---|
| 510 | 512 | 0 | 2.60802E−03 | −5.66451E−05 | 3.02592E−06 |
| | 513 | 0 | −2.15140E−03 | 0 | 0 |
| 520 | 522 | 0 | −1.51973E−03 | 0 | 0 |
| | 523 | 0 | 6.18858E−04 | 0 | 0.0000E+00 |
| 530 | 532 | 0 | −2.76474E−03 | 0 | 0 |
| | 533 | 0 | −1.98199E−04 | 2.10341E−05 | 0 |
| 540 | 542 | 2.13248E+00 | −1.17746E−02 | 4.13932E−03 | −5.38280E−04 |
| | 543 | 0 | −1.48676E−02 | 3.44922E−03 | −5.20403E−04 |
| 570 | 572 | 0 | −2.60983E−05 | 0 | 0 |
| | 473 | −1.81398E+00 | 2.68185E−07 | 0 | 0 |
| 580 | 582 | 0 | −1.25514E−04 | −8.45001E−07 | 0 |
| | 583 | 0 | 8.94758E−04 | 0 | 0 |

Table 15 shows the focal length (in mm) of the lens elements of the fifth embodiment.

TABLE 15

| Lens element | 510 | 520 | 530 | 540 | 550 | 560 | 570 | 580 |
|---|---|---|---|---|---|---|---|---|
| Focal length | −7.632 | −20.183 | 5.368 | −4.233 | −6.562 | 4.533 | 8.303 | 11.299 |

In some embodiments, the effective focal length is 4.35 mm. The half field of view is 34 degrees. The F number is 2.4. The TTL is 22.4 mm. The thickness of the prismatic lens 190 is about 7 mm and the distance between 190 and an image plane is 0.966 mm. The distance (air gap GA4) between aperture AS and the object side surface 542 of the aperture stop is 0.315 mm. The chief ray angle (CRA) is 1.88 degrees. The combination of focal length of lens elements 570 and 580 is 5.114 mm.

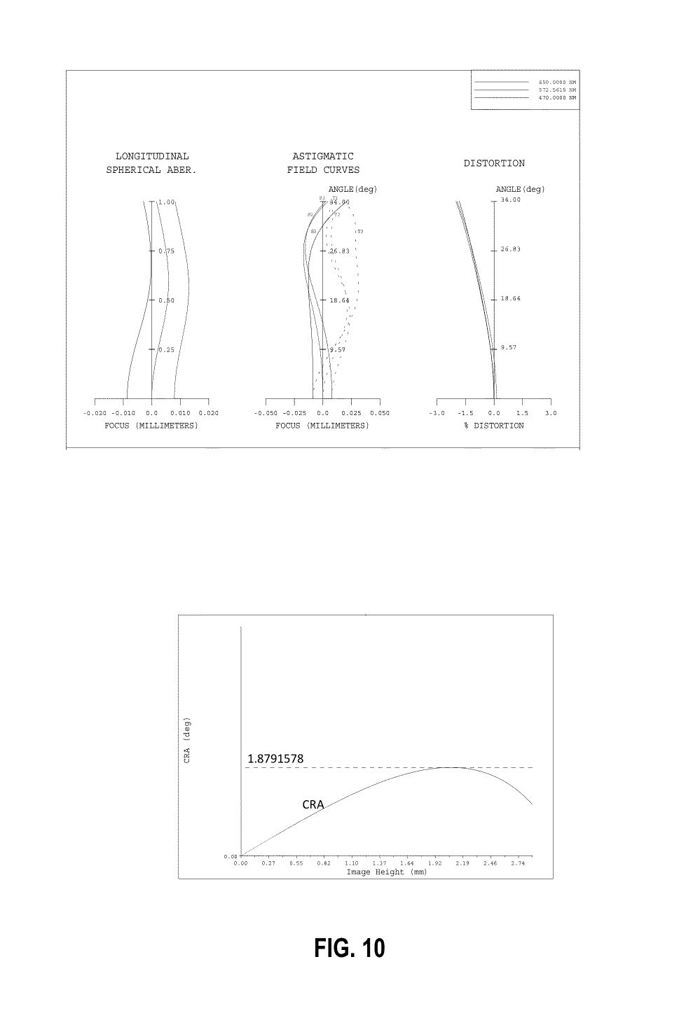

FIG. 10 shows optical characteristics of respective aberrations, astigmatic curves. Distortions and chief ray angle according to the fifth embodiment of the present invention.

Table 16 summarizes various characteristics of the surface design of specific lens elements for optical imaging lenses 100 through 500.

TABLE 16

| | | Lens 100 | Lens 200 | Lens 300 | Lens 400 | Lens 500 |
|---|---|---|---|---|---|---|
| Object side surface of | Shape of center/ | convex/ | convex/ | convex/ | convex/ | convex/ |
| first lens element | periphery area | convex | convex | convex | convex | convex |
| Image side surface of | Shape of center/ | concave/ | concave/ | concave/ | concave/ | concave/ |
| first lens element | periphery area | concave | concave | concave | concave | concave |
| Object side surface of | Shape of center/ | concave/ | convex/ | convex/ | convex/ | convex/ |
| second lens element | periphery area | concave | convex | convex | convex | convex |
| Image side surface of | Shape of center/ | convex/ | concave/ | convex/ | convex/ | concave/ |
| second element | periphery area | convex | convex | convex | convex | concave |
| Object side surface of | Shape of center/ | convex/ | convex/ | concave/ | concave/ | convex/ |
| third element | periphery area | convex | convex | concave | concave | convex |
| Image side surface of | Shape of center/ | concave/ | concave/ | convex/ | convex/ | concave/ |
| third lens element | periphery area | concave | concave | convex | convex | concave |
| Object side surface of | Shape of center/ | concave/ | concave/ | concave/ | concave/ | concave/ |
| fourth element | periphery area | concave | concave | concave | concave | concave |
| Image side surface of | Shape of center/ | concave/ | concave/ | concave/ | concave/ | concave/ |
| fourth lens element | periphery area | concave | concave | concave | concave | convex |
| Object side surface of | Shape of center/ | convex/ | convex/ | convex/ | convex/ | convex/ |
| fiftth element | periphery area | convex | convex | convex | convex | convex |
| Image side surface of | Shape of center/ | concave/ | convex/ | convex/ | convex/ | concave/ |
| fifth lens element | periphery area | concave | convex | convex | convex | concave |
| Object side surface of | Shape of center/ | convex/ | convex/ | convex/ | convex/ | convex/ |
| sixth element | periphery area | convex | convex | convex | convex | convex |
| Image side surface of | Shape of center/ | convex/ | convex/ | convex/ | convex/ | convex/ |
| sixth lens element | periphery area | convex | convex | convex | convex | convex |
| Object side surface of | Shape of center/ | concave/ | concave/ | concave/ | convex/ | convex/ |
| seventh lens element | periphery area | concave | concave | concave | concave | convex |
| Image side surface of | Shape of center/ | convex/ | convex/ | convex/ | concave/ | convex/ |
| seventh lens element | periphery area | convex | concave | concave | concave | convex |
| Object side surface of | Shape of center/ | convex/ | convex/ | convex/ | convex/ | convex/ |
| eighth lens element | periphery area | convex | convex | convex | convex | convex |
| Image side surface of | Shape of center/ | convex/ | convex/ | convex/ | convex/ | convex/ |
| eighth lens element | periphery area | convex | convex | convex | convex | concave |

In embodiments described herein, the ratio of AAG/EFL is between 0.3 and 1.8. AAG is the sum of air gaps between the first lens element through the eighth lens element along the optical axis. EFL is the effective focal length. The ratio of ALT/AAG is between 1.8 and 4.0. ALT is the total thickness of the first to the eighth lens elements along the optical axis. The ratio of AAG/T4 is between 4.5 and 10.0. T4 is the thickness of the fourth lens element along the optical axis. The ratio of T6/G12 is between 0.4 and 2.0. T6 is the thickness of the sixth lens element along the optical axis, and G12 is the air gap between the first and second lens elements along the optical axis. The ratio of T1/T6 is between 0.01 and 0.90. The ratio of T5/T6 is between 0.01 and 1.3. T1 and T5 are the respective thickness of first and fifth lens element along the optical axis.

In embodiments described herein, the ratio of T4/G34 is between 0.01 and 2.0. T4 is the thickness of the fourth lens element along the optical axis, and G34 is the air gap between the third and fourth lens elements along the optical axis. The ratio of T5/T8 is between 0.01 and 1.3. T8 is the thickness of the eighth lens element along the optical axis. The ratio of ALT/G34 is between 5.0 and 23.0. The ratio of AAG/T5 is between 1.3 and 8.2. The ratio of T3/G67 is between 4.5 and 19.3. T3 is the thickness of the third lens element along the optical axis, and G67 is the air gap between the sixth and seventh lens elements along the optical axis

In embodiments described herein, the ratio of T2/T7 is between 0.01 and 2.5. T2 and T7 are the respective thickness of the second and seventh lens elements along the optical axis. The ratio of G23/G78 is between 0.3 and 15.0. G23 and G78 are the air gap between the second and third and between the seventh and eighth lens elements, respectively. The ratio of T5/T7 is between 0.01 and 4.0. The ratio of T3/G23 is between 0.1 and 18.0. The ratio of G23/G34 is between 0.01 and 3.0. The ratio of T7/G23 is between 0.01 and 30.0.

Table 17 summarizes data relating to the five above-described embodiments.

TABLE 17

| | | | | | | Lower | Upper |
|---|---|---|---|---|---|---|---|
| ratio | 1st embod. | 2nd embod. | 3rd embod. | 4th embod. | 5th embod. | limit | limit |
| AAG/EFL | 1.01 | 0.95 | 0.82 | 0.91 | 0.79 | 0.30 | 1.80 |
| ALT/AAG | 2.34 | 2.42 | 2.88 | 2.66 | 3.13 | 1.80 | 4.00 |
| AAG/T4 | 8.04 | 7.54 | 6.47 | 7.18 | 5.74 | 4.50 | 10.00 |
| T6/G12 | 0.95 | 1.03 | 1.33 | 0.94 | 1.34 | 0.40 | 2.00 |
| T1/T6 | 0.38 | 0.32 | 0.44 | 0.47 | 0.43 | 0.01 | 0.90 |
| T5/T6 | 0.48 | 0.47 | 0.54 | 0.80 | 0.29 | 0.01 | 1.30 |
| T4/G34 | 0.40 | 1.08 | 0.60 | 0.63 | 0.39 | 0.01 | 2.00 |
| T5/T8 | 0.77 | 0.44 | 0.65 | 0.63 | 0.28 | 0.01 | 1.30 |
| ALT/G34 | 7.59 | 19.77 | 11.13 | 11.96 | 7.09 | 5.00 | 23.00 |
| AAG/T5 | 4.35 | 3.50 | 2.46 | 2.24 | 6.26 | 1.30 | 8.20 |
| T3/G67 | 14.20 | 6.00 | 6.83 | 6.66 | 16.94 | 4.50 | 19.30 |
| T2/T7 | 1.32 | 1.83 | 1.49 | 1.50 | 0.22 | 0.01 | 2.50 |
| G23/G78 | 5.01 | 9.13 | 3.28 | 4.31 | 0.89 | 0.30 | 15.00 |
| T5/T7 | 0.77 | 1.97 | 2.41 | 2.94 | 0.20 | 0.01 | 4.00 |
| T3/G23 | 2.83 | 0.66 | 2.08 | 1.54 | 11.29 | 0.10 | 18.00 |
| G23/G34 | 0.37 | 1.80 | 0.36 | 0.49 | 0.10 | 0.01 | 3.00 |
| T7/G23 | 2.59 | 0.66 | 1.83 | 1.39 | 18.00 | 0.10 | 30.00 |

The present invention is not limited to the above-described embodiments. The invention is intended to cover all modifications and equivalents within the scope of the appended claims.

What is claimed is:

1. An optical imaging lens comprising, in order from an object side to an image side, a first lens element, a second lens element, a third lens element, a fourth lens element, a fifth lens element, a sixth lens element, a seventh lens element, and an eighth lens element arranged along an optical axis, each lens element having an object-side surface facing toward the object side and an image-side surface facing toward the image side, wherein:
the first lens element has a negative refractive power, the object-side surface of the first lens element has a convex portion in a vicinity of an outer circumference and the image-side surface of the first lens element has a concave portion in a vicinity of an optical axis;
the second lens element is made of plastic;
the third lens element has a refractive power;
the object-side surface of the fourth lens element has a concave portion in the vicinity of the optical axis and the image-side surface has a concave portion in the vicinity of the optical axis;
the object-side surface of the fifth lens element has a convex portion in the vicinity of the optical axis;
the object-side surface of the sixth lens element has a convex portion in the vicinity of the optical axis and the image-side surface has a convex portion in the vicinity of the optical axis;
the seventh lens element has a refractive power;
the eighth lens element has a positive refractive power, the object-side surface of the eighth lens element has a convex portion in the vicinity of the optical axis and a convex portion in the vicinity of the outer circumference; and
the optical imaging lens only has eight lens elements having a refractive power.

2. The optical imaging lens of claim 1, wherein a thickness of the second lens element along the optical axis is defined as T2 and a thickness of the seventh lens element along the optical axis is defined as T7, and wherein T2 and T7 satisfy the relation:
T2/T7≦2.5.

3. The optical imaging lens of claim 1, wherein an air gap between the second and third lens elements along the optical axis is defined as G23 and an air gap between the seventh and eighth lens elements along the optical axis is defined as G78, and wherein G23 and G78 satisfy the relation:
G23/G78≦15.

4. The optical imaging lens of claim 1, wherein a thickness of the fifth lens element along the optical axis is defined as T5 and a thickness of the eighth lens element along the optical axis is defined as T8, and wherein T5 and T8 satisfy the relation:
T5/T8≦1.3.

5. The optical imaging lens of claim 1, wherein a sum of thicknesses of the first, second, third, fourth, fifth, sixth, seventh, and eighth lens elements along the optical axis is defined as ALT and an air gap between the third and fourth lens elements along the optical axis is defined as G34, and wherein ALT and G34 satisfy the relation:
ALT/G34≦23.

6. The optical imaging lens of claim 1, wherein a thickness of the sixth lens element along the optical axis is defined as T6 and an air gap between the first and second lens elements along the optical axis is defined as G12, and wherein T6 and G12 satisfy the relation:
T6/G12≦2.

7. The optical imaging lens of claim 1, wherein a thickness of the first lens element along the optical axis is defined as T1 and a thickness of the sixth lens element along the optical axis is defined as T6, and wherein T1 and T6 satisfy the relation:
T1/T6≦0.9.

8. An optical imaging lens comprising, in order from an object side to an image side, a first lens element, a second lens element, a third lens element, a fourth lens element, a fifth lens element, a sixth lens element, a seventh lens element, and an eighth lens element arranged along an optical axis, each lens element having an object-side surface facing toward the object side and an image-side surface facing toward the image side, wherein:
the object-side surface of the first lens element has a convex portion in a vicinity of an optical axis and the image-side surface of the first lens element has a concave portion in the vicinity of the optical axis;
the second lens element has a refractive power;
the third lens element is made of plastic;
the fourth lens element has a negative refractive power, the object-side surface of the fourth lens element has a concave portion in the vicinity of the optical axis;
the fifth lens element has a positive refractive power, the object-side surface of the fifth lens element has a convex portion in the vicinity of the optical axis;
the object-side surface of the sixth lens element has a convex portion in the vicinity of the outer circumference and the image-side surface of the sixth lens element has a convex portion in the vicinity of the optical axis;
the seventh lens element has a refractive power;
the object-side surface of the eighth lens element has a convex portion in the vicinity of the optical axis and the image-side surface of the eighth lens element has a convex portion in the vicinity of the optical axis; and
the optical imaging lens only has eight lens elements having a refractive power.

9. The optical imaging lens of claim 8, wherein a thickness of the fifth lens element along the optical axis is defined as T5 and a thickness of the seventh lens element along the optical axis is defined as T7, and wherein T5 and T7 satisfy the relation:
T5/T7≦4.0.

10. The optical imaging lens of claim 8, wherein a thickness of the third lens element along the optical axis is defined as T3 and an air gap between the second and third lens elements along the optical axis is defined as G23, and wherein T3 and G23 satisfy the relation:
T3/G23≦18.

11. The optical imaging lens of claim 8, wherein a sum of air gaps between the first lens element through the eighth lens element along the optical axis is defined as AAG and a thickness of the fifth lens element along the optical axis is defined as T5, and wherein AAG and T5 satisfy the relation:
AAG/T5≦8.2.

12. The optical imaging lens of claim 8, wherein a thickness of the third lens element along the optical axis is defined as T3 and an air gap between the sixth and seventh lens elements along the optical axis is defined as G67, and wherein T3 and G67 satisfy the relation:
T3/G67≦19.3.

13. The optical imaging lens of claim 8, wherein a sum of air gaps between the first lens element through the eighth lens element along the optical axis is defined as AAG and an effective focal length of the optical imaging lens is defined as EFL, and wherein AAG and EFL satisfy the relation:
AAG/EFL≦1.8.

14. The optical imaging lens of claim 8, wherein a sum of thicknesses of the first, second, third, fourth, fifth, sixth, seventh, and eighth lens elements along the optical axis is defined as ALT and a sum of air gaps between the first lens element through the eighth lens element along the optical axis is defined as AAG, and wherein ALT and AAG satisfy the relation:
ALT/AAG≦4.

15. An optical imaging lens comprising, in order from an object side to an image side, a first lens element, a second lens element, a third lens element, a fourth lens element, a fifth lens element, a sixth lens element, a seventh lens element, and an eighth lens element arranged along an optical axis, each lens element having an object-side surface facing toward the object side and an image-side surface facing toward the image side, wherein:
the image-side surface of the first lens element has a concave portion in a vicinity of an optical axis and a concave portion in a vicinity of an outer circumference;
the second and third lens elements have a refractive power;
the object-side surface of the fourth lens element has a concave portion in the vicinity of the optical axis and a concave portion in the vicinity of the outer circumference;
the fifth lens element has a positive refractive power, the object-side surface of the fifth lens element has a convex portion in the vicinity of the outer circumference;
the sixth lens element has a positive refractive power, the image-side surface of the sixth lens element has a convex portion in the vicinity of the optical axis and a convex portion in the vicinity of the outer circumference;
the seventh lens element is made of plastic;
the object-side surface of the eighth lens element has a convex portion in the vicinity of the optical axis and a convex portion in the vicinity of the outer circumference; and
the optical imaging lens only has eight lens elements having a refractive power.

16. The optical imaging lens of claim 15, wherein an air gap between the second and third lens elements along the optical axis is defined as G23 and an air gap between the third and fourth lens elements along the optical axis is defined as G34, and wherein G23 and G34 satisfy the relation:
G23/G34≦3.

17. The optical imaging lens of claim 15, wherein a thickness of the seventh lens element along the optical axis is defined as T7 and an air gap between the second and third lens elements along the optical axis is defined as G23, and wherein T7 and G23 satisfy the relation:
T7/G23≦30.

18. The optical imaging lens of claim 15, wherein a thickness of the fifth lens element along the optical axis is defined as T5 and a thickness of the sixth lens element along the optical axis is defined as T6, and wherein T5 and T6 satisfy the relation:
T5/T6≦1.3.

19. The optical imaging lens of claim 15, wherein a thickness of the fourth lens element along the optical axis is defined as T4 and an air gap between the third and fourth lens elements along the optical axis is defined as G34, and wherein T4 and G34 satisfy the relation:
T4/G34≦2.

20. The optical imaging lens of claim 15, wherein a sum of air gaps between the first lens element through the eighth lens element along the optical axis is defined as AAG and a thickness of the fourth lens element along the optical axis is defined as T4, and wherein AAG and T4 satisfy the relation:
AAG/T4≦10.
